(19) United States
(12) Patent Application Publication
(10) Pub. No.: US 2022/0372248 A1
(43) Pub. Date: Nov. 24, 2022

(54) RESIN COMPOSITIONS FOR OPTICAL FILMS

(71) Applicant: DelStar Technologies, Inc., Middletown, DE (US)

(72) Inventor: James Galica, Westhampton, MA (US)

(73) Assignee: DelStar Technologies, Inc., Middletown, DE (US)

(21) Appl. No.: 17/628,290

(22) PCT Filed: Jul. 6, 2020
(86) PCT No.: PCT/US20/40940

§ 371 Date: Jan. 19, 2022

Related U.S. Application Data
(60) Provisional application No. 62/876,171, filed on Jul. 19, 2019.

(51) Int. Cl. C08K 5/3475; C08K 5/3435; C08K 5/17

(52) U.S. Cl. CPC C08K 5/3475; C08K 5/3435; C08K 5/17

(57) ABSTRACT

Compositions, laminates, films and/or composites made from thermoplastic polymers, such as thermoplastic polyurethane (TPU) are described. The films have one or more optical layers made from materials that allow the transmission of visible light and reflect or absorb UV light. An optical film is made from one or more TPU resins including a first UV absorber of the benzotriazole family or the triazin family, a light stabilizer, and a second UV absorber selected from a group consisting of benzotriazoles, benzophenones, triazin or benzylidene malonate. The second UV absorber may be present in a base resin combined with the TPU resin. The optical film is capable of blocking at least 99% of light having a wavelength

### CROSS-REFERENCE TO RELATED APPLICATIONS

This application is a national stage application, filed under 35 U.S.C. § 371, of International Patent Application No. PCT/US2020/040940 filed on Jul. 6, 2020, which claims the benefit of U.S. Provisional Application Ser. No. 62/876,171, filed Jul. 19, 2019, the entire disclosure of which is incorporated herein by reference for all purposes.

### BACKGROUND

The field relates to compositions, composites, laminates and/or films having one or more optical materials or layers that block UV radiation while being substantially transparent to visible light.

Film and laminates having high optical transparency to visible light are desirable in a number of applications. For example, films having high optical transparency are used in vehicle windshields and sunroofs, food packaging, optical disk devices, residential and commercial windows and the like.

Solar radiation is radiant (electromagnetic) energy from the sun. It provides light and heat for the Earth and energy for photosynthesis. This radiant energy is necessary for the metabolism of the environment and its inhabitants. The solar radiation spectrum is divided into different radiation regions defined by the wavelength range. In general, human eyes are capable of sensing visible lights with wavelengths in the range of about 400 nm to 700 nm. Invisible light comprises infrared rays with wavelengths of about 700 nm to 1 m and ultraviolet rays with wavelengths of about 10 nm to 400 nm.

The various radiation regions of the solar spectrum can impose different effects on the environment and humans. Although small amounts of UV light can be beneficial for humans, prolonged exposure to UV radiation can damage human skin and lead to acute and chronic health issues. Similarly, prolonged exposure to UV light can also damage or tarnish goods, such as upholstery and furniture.

Thus, while solar radiation brings natural lighting to a building or an automobile interior through windows, it also brings along unwanted effects from UV radiation. UV radiation causes direct harm and damage to objects in the interior of a space. As such, a functional window that transmits visible light but blocks UV light is essential for buildings and automobiles to reduce the electricity load and to protect all objects and users inside.

Laminated glass windows with polymeric interlayers are commonly employed for safety concerns and improved energy efficiency, with polyvinyl butyral (PVB) resin sheets being the most common glass laminate. Conventional automotive or architectural glazing or window structures often include a laminate typically made of two rigid glass or plastic sheets and an interlayer of plasticized polyvinyl butyral (PVB). PVB sheets are commonly used because they can hold sharp glass fragments in place when the glass is broken. Thus, PVB laminated safety glass is widely applied in building and automobile windows, show cases, and other places where human interactions are highly involved.

An optical filter is a device that selectively transmits and/or blocks light of different wavelengths. The optical properties filters are completely described by their frequency response, which specifies how the magnitude and phase of each frequency component of an incoming signal is modified by the filter. Optical layers or filters can be disposed within, or between, PVB sheets to block UV light passing through the laminated window.

PVB layers, however, have certain drawbacks in laminates, such as glass windows. For example, a high level of moisture can wick into the PVB layers during use. This moisture can ultimately cause failure of the laminate or reduce the quality of visible light passing through the window. In addition, PVB generally has a high modulus and a low tensile strength, which can negatively impact the performance of the glazing in such applications as windows and automobile windshields. Moreover, PVB interlayers can bleed between the film layers at edges and cause enough separation to create highly colored iridescence called “edge brightening”. Edge brightening is not a desirable characteristic in glass laminates of this type.

What is needed, therefore, are improved compositions with optical layers, such as films, composites or laminates for vehicle and building windows, that are more durable and less susceptible to moisture penetration and/or bleeding, while still providing protection from the adverse effects of UV radiation and still being thin enough to support lower material costs in a competitive market.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

In aspects, illustrative embodiments relate to films, compositions, laminates and/or composites made from thermoplastic polymers, preferably thermoplastic polyurethane (TPU). The films have one or more optical materials and/or layers made from materials that allow the transmission of visible light and reflect or absorb UV light. In certain embodiments, illustrative compositions are made from one or more resins, at least one of which is an aliphatic thermoplastic polyurethane (TPU) resin. In other embodiments, illustrative embodiments relate to glass composites, such as window glass, that include TPU and optical materials therein.

In embodiments, illustrative films and compositions are less susceptible to moisture wicking into the TPU layers, providing a more durable optical composition and improving the quality of visible light passing therethrough. TPU also has desirable properties that allow it to be etched into plastics. In addition, the embodiments including illustrative TPU compositions are less susceptible to bleeding between the film layers at edges, thereby reducing edge brightening.

The TPU layers are preferably selected from a material that provides sufficient transparency to visible light and exhibits suitable adhesion to glass, polycarbonate, acrylic, cellulose acetate butyrate, or other surfaces which the layers may contact. In certain embodiments, the TPU layers preferably have a storage modulus sufficient to substantially absorb and dissipate the kinetic energy of air particulates that contact its surface, such as rain, hail, wind, dirt and other contaminants. At the same time, the TPU material preferably has substantial tear and abrasion resistance, thereby protecting the film from adverse environmental conditions.

In one aspect, illustrative optical films made from aliphatic thermoplastic polyurethane (TPU) resin compositions are provided. The resin compositions include an aliphatic thermoplastic polyurethane (TPU) resin, a first UV absorber selected from the group consisting of the benzotriazole family or the triazin family, a light stabilizer, and a second UV absorber. The second UV absorber is preferably selected from a group consisting of benzotriazoles, benzophenones, triazin or benzylidene malonate.

In certain embodiments, the TPU resin is present in an amount from about 95% to about 99.99% by weight. The first UV absorber is present in the TPU resin in an amount from about 0.1% to about 1.0% by weight. The second US absorber is present from about 0.01% to about 2.0% by weight. In a preferred embodiment, the first and second UV absorbers are present in a combined amount of about 0.1% to about 3% by weight.

In certain embodiments, the second UV absorber is selected from the group consisting of benzotriazole-type absorbers or benzophenone-type absorbers.

In certain embodiments, the light stabilizer comprises an amine light stabilizer (HALS or NOR-HALS). In an exemplary embodiment, the light stabilizer may be produced by a mixing bis (1,2,2,6,6-pentamethyl-4-piperidyl) sebacate and methyl 1,2,2,6,6-pentamethyl-4-piperidyl sebacate. In embodiments, bis (1,2,2,6,6-pentamethyl-4-piperidyl) sebacate and methyl 1,2,2,6,6-pentamethyl-4-piperidyl sebacate are mixed in a 3:1 ratio.

In certain embodiments, the second UV absorber is combined with the one or more TPU resins as a concentrate in a base resin, the ratio of the TPU resin to base resin ranging from about 20:1 to about 3:1. The loading percentage of concentrate in the base resin ranges from about 0.5% to about 10%. In one exemplary embodiment, the loading percentage of the second UV absorber as a concentrate is about 0.5% by weight in the base resin, and a thickness of the film is no greater than 30 mils. In another exemplary embodiment, the concentration loading of the second UV absorber is about 8.5 PPH and a thickness of the film is no greater than 15 mils.

In embodiments, illustrative optical films are capable of blocking at least about 95% of light having a wavelength ranging from about 100 nm to about 410 nanometers, preferably between about 380 and 410 nanometers. In an exemplary embodiment, the optical films are capable of blocking greater than about 99.9% of light having a wavelength ranging from about 380 nm to 400 nm or at least 99% of light having a wavelength of about 400 nm.

In certain embodiments, the optical films have a yellowness index (YI value) that is no greater than about 3.0, preferably no greater than about 2.5. In certain embodiments, the YI value is less than 2.0.

In certain embodiments, the thickness of the film and the concentration of the second UV absorber is optimized. In one embodiment, a loading percentage of the second UV absorber as a concentrate is about 0.5% by weight in a base resin, and a thickness of the film is no greater than 30 mils. In another embodiment, the concentration loading of the second UV absorber is about 8.5 PPH and the thickness of the film is no greater than 15 mils.

In another aspect, illustrative compositions comprise an aliphatic thermoplastic polyurethane (TPU) resin that includes a first UV absorber selected from the group consisting of the benzotriazole family or the triazin family, and a light stabilizer. The composition further comprises a base resin that includes a second UV absorber. The second UV absorber is preferably selected from a group consisting of benzotriazoles, benzophenones, triazin or benzylidene malonate.

In certain embodiments, the base resin includes a second TPU resin. A ratio of the TPU resin to the base resin including the second UV absorber ranges from about 20:1 to about 3:1, preferably from about 10:1 to about 7:1. The loading percentage of concentrate in the base resin ranges from about 0.5% to about 10%. In one exemplary embodiment, the loading percentage of the second UV absorber as a concentrate is about 0.5% by weight in the base resin, and a thickness of the film is no greater than 30 mils. In another exemplary embodiment, the concentration loading of the second UV absorber is about 8.5 PPH and a thickness of the film is no greater than 15 mils.

In another aspect, illustrative embodiments relate to a composite including a first layer of glass, a second layer of glass, and a film between the first layer and the second layer of glass. The film is made from a thermoplastic polyurethane (TPU) resin composition, a first UV absorber from the benzotriazole family or the triazin family, a light stabilizer, and a second UV absorber.

In certain embodiments, the second UV absorber is combined with the TPU resin as a concentrate in a base resin, the ratio of TPU resin to the base resin including the second UV absorber concentratee ranging from about 20:1 to about 3:1. The loading percentage of concentrate in the base resin ranges from about 0.5% to about 10%. In one exemplary embodiment, the loading percentage of the second UV absorber as a concentrate is about 0.5% by weight in the base resin, and a thickness of the film is no greater than 30 mils. In another exemplary embodiment, the concentration loading of the second UV absorber is about 8.5 PPH and a thickness of the film is no greater than 15 mils.

In embodiments, illustrative composites are capable of blocking at least about 95% of light having a wavelength ranging from about 100 nm to about 410 nanometers, preferably between about 380 and 410 nanometers. In an exemplary embodiment, the composites are capable of blocking greater than about 99.9% of light having a wavelength ranging from about 380 nm to 400 nm or at least 99% of light having a wavelength of about 400 nm.

In another aspect, illustrative embodiments relate to a method for producing optical films. The methods include: preparing a mixture by combining a) a first resin composition having a TPU, a first UV absorber of the benzotriazole family or the triazin family, and a light stabilizer and b) a concentrate containing a second UV absorber combined with a second resin; melting and extruding the mixture of the first and second resins; and feeding the mixture containing the first and second resins through a die to create an optical film.

In certain embodiments, a loading concentration of the second UV absorber in the second resin is about 10 PPH. In an exemplary embodiment, the concentrate comprises Tinuvin 326.

In certain embodiments, the combining includes dry blending at least 7 parts per hundred of the second resin into the first resin.

It is to be understood that both the foregoing general description and the following detailed description are exemplary and explanatory only and are not restrictive. Additional features will be set forth in part in the description which follows or may be learned by practice thereof.

### BRIEF DESCRIPTION OF THE DRAWINGS

The accompanying drawings, which are incorporated in and constitute a part of this specification, illustrate several embodiments and together with the description serve to explain the principles of the disclosure.

FIG. 1 is a cross-sectional view of a composite glass including one of the optical films in accordance with an illustrative embodiment.

### DETAILED DESCRIPTION

This description and the accompanying drawings illustrate exemplary embodiments and should not be taken as limiting, with the claims defining the scope of the present description, including equivalents. Various mechanical, compositional, structural, and operational changes may be made without departing from the scope of this description and the claims, including equivalents. In some instances, well-known structures and techniques have not been shown or described in detail so as not to obscure the description. Like numbers in two or more figures represent the same or similar elements. Furthermore, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment. Moreover, the depictions herein are for illustrative purposes only and do not necessarily reflect the actual shape, size, or dimensions of the system or illustrated components.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

The present optical films are made from a thermoplastic polyurethane (TPU) resin composition. The TPU resin composition includes a first UV absorber, a light stabilizer, and a second UV absorber. The films made from such TPU resin compositions have desirable optical characteristics provided by the combination of UV absorbers.

TPU resin compositions may include any aliphatic polyether-based TPU that provides sufficient transparency and may exhibit suitable adhesion to glass, polycarbonate, acrylyic, cellulose acetate butyrate, or other surfaces which the films may contact. In embodiments, suitable TPU resins may be polyether-based and made from methylene diphenyl diisocayanate (MDI), polyether polyol, and butanediol. In embodiments, the TPU resin may be Estane AG-8451 Resin sold by Lubrizol. In embodiments the TPU resin may be present in the resin composition in an amount from about 95 to about 99.99% by weight; in certain embodiments, from about 98 to about 99.99% by weight, in other embodiments from about 99.5% to about 99.99%.

TPU resin compositions also include a first UV absorber. In embodiments the first UV absorber may be present in the TPU resin composition in an amount from about 0.1 to about 1% by weight; in embodiments, from about 0.3 to about 0.5% by weight.

In certain embodiments, the first UV absorber may be any suitable UV absorber made from compounds in the benzotriazole family. Non-limiting examples of benzotriazole-type UV absorbers include compounds of the formula:

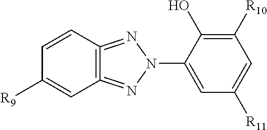

wherein R₉, R₁₀, and R₁₁ are individually selected from hydrogen, a group having a formula CₐH_{b}N_{c}O_{d}Sₑ wherein a, b, c, d, and e are from 0 to 30, and halogen. Non-limiting examples of benzotriazole-type UV absorbers which may be used as the first UV absorber include 2-(2H-benzotriazol-2-yl)-4,6-bis(1,1-dimethylpropyl)-phenol; phenol, 2,2′-methylene-bis(6-(2H-benzotriazol-2-yl)-4-(1,1,3,3-tetramethyl-butyl)); 2-(2′-Hydroxy-3′, 5′-di-t-amylphenyl) benzotriazole; 2-Hydroxy-4-methoxybenzophenone; 2-[2-hydroxy-3,5-di(1,1-dimethylbenzyl)phenyl]; 2-(5-tert-Butyl-2-hydroxyphenyl)-2H benzotriazole; 2-(2-hydroxy-5-methylphenyl) benzotriazole; 2-(2H-Benzotriazol-2-yl)-4-(1,1,3,3-tetramethylbutyl)phenol; 2,4-Di-tert-butyl-6-(5-chloro-2H-benzotriazol-2-yl)phenol; 2-(2′-Hydroxy-3′,5′-di-tert-butylphenyl)benzotriazole; 3-(2H-Benzotriazolyl)-5-(1,1-di-methylethyl)-4-hydroxy-benzenepropanoic acid octyl esters; methyl 3-[3-tert-butyl-4-hydroxy-5-(5-chloro-2H-benzotriazol-2-yl)phenyl]propionate; 2-(2H-Benzotriazol-2-yl)-6-(1-methyl-1-phenylethyl)-4-(1,1,3,3-tetramethylbutyl)phenol; reaction products of methyl 3-(3-(2H-benzotriazole-2-yl)-5-t-butyl-4-hydroxyphenyl) propionate/PEG 300; 2-(2′-Hydroxy-5′-(2-hydroxyethyl))-benzotriazole; 2-(2′-Hydroxy-5′methacryloxyethylphenyl)-2H-benzotriazole; 2-[4,6-Bis(2,4-dimethylphenyl)-1,3,5-triazin-2-yl]-5-(octyloxy) phenol; or any combinations thereof. In other embodiments, the first UV absorber may be of the benzophenone family. Non-limiting examples of benzophenone-type UV absorbers which may be used as the first UV absorber include: 2, 4-dihydroxy benzophenone; 2-hydroxy-4-methoxybenzophenone; 2-hydroxy-4-n-(octyloxy) benzophenone; 2,2′,4,4′-tetrahydroxybenzophenone; 2,2′-dihydroxy-,4,4′-dimethoxy benzophenone; sulisobenzone; 2-hydroxy-4-n-octoxybenzophenone; 2,2′-dihydroxy-4-methoxy benzophenone; 2-hydroxy-4-methoxybenzophenone; 2,2′-dihydroxy-4,4′-dimethoxy benzophenone; 2,2′,4,4′-tetrahydroxybenzophenone; and combinations thereof.

In other embodiments, the first UV absorber may be of the triazin family. Non-limiting examples of triazin-type UV absorbers which may be used as the first UV absorber include: 2-(4,6-diphenyl-1,3,5-triazin-2-yl)-5-[(hexyl)oxy]-phenol.

In other embodiments, the first UV absorber may be of the benzylidene malonate family. Non-limiting example of benzylidene malonate-type UV absorbers which may be used as the first UV absorber include: Propanedioic acid [(4-methoxyphenyl)-methylene]-dimethyl ester).

Other non-limiting examples of benzophenone-type UV absorbers which may be used as the first UV absorber include: 2, 4-dihydroxy benzophenone; 2-hydroxy-4-methoxybenzophenone; 2-hydroxy-4-n-(octyloxy) benzophenone; 2,2′,4,4′-tetrahydroxybenzophenone; 2,2′-dihydroxy-,4,4′-dimethoxy benzophenone; sulisobenzone; 2-hydroxy-4-n-octoxybenzophenone; 2,2′-dihydroxy-4-methoxy benzophenone; 2-hydroxy-4-methoxybenzophenone; 2,2′-dihydroxy-4,4′-dimethoxy benzophenone; 2,2′,4,4′-tetrahydroxybenzophenone; and combinations thereof.

TPU resin compositions also include a light stabilizer. Suitable light stabilizers primarily protect the polymers of the optical film from the adverse effects of photo-oxidation caused by exposure to UV radiation. In embodiments, the light stabilizer may serve a secondary function of acting as a thermal stabilizer, for low to moderate levels of heat. In embodiments, the light stabilizer of a resin composition may be included in an amount from about 0.1 to about 1% by weight; in embodiments, from about 0.1 to about 0.2% by weight.

In certain embodiments, suitable light stabilizers may be derivatives of tetramethylpiperidine. In embodiments, the light stabilizer may be any suitable hindered amine light stabilizer (HALS or NOR-HALS). In certain embodiments, the light stabilizer may be made by combining bis (1,2,2,6,6-pentamethyl-4-piperidyl) sebacate with methyl 1,2,2,6,6-pentamethyl-4-piperidyl sebacate.

Non-limiting examples of light stabilizers useful in the illustrative resin compositions include bis-(2,2,6,6-tetramethyl-4-piperidinyl)sebacate; bis-(I,2,2,6,6-pentamethyl-4-piperidinyl)-2-n-butyl-2-(3,5-di-tert-butyl-4-hydroxybenzyl) malonate; propanedioic acid, [(4-methoxyphenyl)-methylene]-bis-(1,2,2,6,6-pentamethyl-4-piperidinyl) ester; 10 wt % of dimethyl succinate polymer with 4-hydroxy-2,2,6,6, -tetramethyl-I-piperidineethanol and 90 wt % of N,N′″-[1,2-ethanediylbis[[[4,6-bis[butyl(1,2,2,6,6-pentamethyl-4-piperidinyl)amino]-1,3,5-traizin-2-yl]imino]-3,l-propanediyl]] bis [N′N″-dibutyl-N′N″-bis(I,2,2,6,6-pentamethyl-4-piperidinyl)]-l; or combinations thereof. In embodiments, the light stabilizer is bis(1,2,2,6,6-pentamethyl-4-piperidyl) sebacate combined with methyl 1,2,2,6,6-pentamethyl-4-piperidyl sebacate Chisorb 292 sold by Double Bond Chemical Ind. Co., Ltd., Eversorb 93, sold by Everlight Chemical, RIASORB UV-292 sold by Rianion Corp, Thasorb UV-292 sold by Rianlon Corp., Sabostab UV 65, sold by SABO, Westco UV-292 sold by Western Reserve Chemical, UV-292/UV-292HP sold by Performance Solutions, Inc., and FENTASTAB 292 sold by Jiangsu Forpi Chemicals Co., Ltd or any combination thereof.

TPU resin compositions also include a second UV absorber which, when combined with the TPU resin, light stabilizer and the first UV absorber, imparts a particular combination of optical characteristics to a film made from the resin composition; namely, the resulting film is capable of blocking about 95% of light having a wavelength ranging from about 10 to about 410 nm, preferably about 380 nm to about 410 nm. In certain embodiments, the film is capable of blocking greater than 99.9% of light having a wavelength ranging from about 380 nm to 400 nm and has a yellowness index (YI value) that is no greater than 3.0, preferably no greater than 2.5. In other embodiments, the film is capable of blocking no less than 99% of light having a wavelength of about 400 nm.

In embodiments, the second UV absorber is present in an amount from about 0.001% to about 2.0% by weight; in embodiments, the second UV absorber is present in the resin composition in an amount from about 0.5% to about 1.0% by weight.

In certain embodiments, the second UV absorber may be any suitable UV absorber of the benzotriazole family, the benzophenone family, the triazin family or the benzylidene malonate family that provides the foregoing combination of optical characteristics, such as the compounds lists above with respect to the first UV absorber. Non-limiting examples of benzotriazole-type UV absorbers suitable for use as the second UV absorber include compounds of the formula:

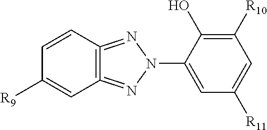

wherein R₉, R₁₀, and R₁₁ are individually selected from hydrogen, a group having a formula CₐH_{b}N_{c}O_{d}Sₑ wherein a, b, c, d, and e are from 0 to 30, and halogen, where at least one of R₉, R₁₀, or R₁₁ is halogen. In embodiments, the second UV absorber is phenol, 2-(5-chloro-2H-benzotriazol-2-yl)-6-(1,1-dimethylethyl)-4-methyl.

The resin composition may be prepared by preparing a composition including one or more TPU resins, the first UV absorber and a light stabilizer. The composition is combined with a concentrate containing the second UV absorber in a base resin including the same or a different TPU resin. In embodiments, the base resin and the concentrate are dry blended. In embodiments, the ratio of TPU resin to base resin is from about 20:1 to about 3:1, preferably from about 10:1 to about 7:1. The second UV absorber may be present in the concentrate by an amount of about 9.5% by weight.

The optical film preferably has a thickness of about 5 mils to 50 mils. In one embodiment, the concentration of the second UV absorber is about 0.8% by weight and the thickness of the film is no greater than 15 mils. In another embodiment, the concentration of the second UV absorber is about 0.5% by weight and the thickness of the film is no greater than 25 mils.

In an exemplary embodiment, illustrative optical films may have: a thickness in the range of from about 1 mil to about 50 mils, in embodiments from about 15 mils to about 30 mils; a UV cutoff of about 300 nm to 500 nm, preferably about 350 nm to 400 nm; a light transmission rate of no more than 0.5% to 10% at a wavelength of 400 nm, in embodiments a light transmission rate of no more than about 1%-5% at a wavelength of 400 nm; and a YI (ASTM E313) value that is no greater than 2.5, preferably no greater than about 2.0.

The present optical films may be prepared by a single screw cast film extrusion process, or any other suitable extrusion process within the purview of those of skill in the art. In embodiments, the process begins by dry blending a concentrate containing the second UV absorber with a base resin as described above to provide a mixture. The mixture of base resin and concentrate are then melted and mixed by an extruder. The melted resin composition is then filtered and fed to a die system. The resulting homogenous blend of molten polymer then travels through a flat die system to adopt a final flat film shape. Upon exiting the die, the molten web enters a cooling unit, where it is cooled using a water-cooled chill roll or any suitable cooling mechanism as is known by one of skill in the art. The film is then fed downstream where the edges may be trimmed and the film may be rolled up on a shaft to produce a roll of material.

### EXAMPLES

An optical film is prepared by single screw extrusion from the following ingredients: a TPU resin (AG-8451 sold by Lubrizol) containing a light stabilizer produced by a reaction mass of bis (1,2,2,6,6-pentamethyl-4-piperidyl) sebacate and methyl 1, 2, 2, 6, 6-pentamethyl-4-piperidyl sebacate (equivalent to Tinuvin 292 sold by BASF, CAS No. 1065336-91-5) and 2-(2H-benzotriazol-2-yl)-4,6-bis(1,1-dimethylpropyl)-phenol as a first UV absorber (equivalent to Tinuvin 328 sold by BASF, CAS No. 25973-55-1). This film is 30 mils thick and is identified as a control film in Table 1 below.

Five additional films (films 1-5) were prepared by compression molding from melt blended formulation prepared in a heated Brabender High Shear Mixer from a TPU resin (AG-8451 sold by Lubrizol) containing a light stabilizer produced by a reaction mass of bis (1,2,2,6,6-pentamethyl-4-piperidyl) sebacate and methyl 1,2,2,6,6-pentamethyl-4-piperidyl sebacate (equivalent to Tinuvin 292 sold by BASF, CAS No. 1065336-91-5) and 2-(2H-benzotriazol-2-yl)-4,6-bis(1,1-dimethylpropyl)-phenol as a first UV absorber (equivalent to Tinuvin 328 sold by BASF, CAS No. 25973-55-1), and 0.5% of a second UV absorber. The added UV absorber present for each of films 1-5 is identified in Table 1 below.

TABLE 1

| | Added | | | UV | % Light |
|---|---|---|---|---|---|
| | UV | | Loading | Cutoff | Blocked |
| | Absorber | Thickness | (%) | (nm) | @400 nm |
| AG8451 | NONE | 30 mils | — | 375.8 | 21.1 |
| Control | | | | | |
| Film 1 | 2,4-Dihydroxy- | ~30 mils | 0.50% | 382.3 | 39.4 |
| | benzophenone | | | | |
| Film 2 | Tinuvin 326 | ~30 mils | 0.50% | 401.1 | 99.6 |
| Film 3 | Tinuvin 360 | ~30 mils | 0.50% | 390.5 | 63.7 |
| Film 4 | Tinuvin 640 | ~30 mils | 0.50% | 387.8 | 58.5 |
| Film 5 | Cyasorb UV- | ~30 mils | 0.50% | 383.4 | 33.2 |
| | 5411 | | | | |

| Avg. % | Avg. % | | |
|---|---|---|---|
| Light | Light | | YI |
| Blocked | Blocked | Avg. % T | ASTM |
| (380-400 nm) | (390-410 nm) | (400-900 nm) | E313 |
| 61.15 | 26.2 | 92.6 | 0.54 |
| 78.31 | 44.2 | 89.3 | 2.42 |
| 99.95 | 94.9 | 86 | 4.57 |
| 93.08 | 64.3 | 85 | 4.97 |
| 89.28 | 57.9 | 83.6 | 4.5 |
| 75.56 | 39.3 | 88.8 | 2.18 |

Table 1 shows that by adding a concentrate containing Tinuvin 326, an optical film having a UV cutoff of about 400 nm may be achieved. As used herein, UV cutoff generally refers to the wavelength at which substantially all of the UV light is blocked by the UV absorber, typically being absorbed by organic molecules and converted to heat. The percentage of light blocked at 400 nm with the added Tinuvin 326 is greater than the films having the alternative additives. Although the film treated with Tinuvin 360 has a UV cutoff that is closer to 400 than the other films, the YI value is surprisingly greater than Film 2's YI value, despite film 2 having a higher UV cutoff and light blockage percentage. The higher YI values for films 1-5 versus the control film are attributed to processing using the Brabender High Shear Mixer for laboratory preparation of films 1-5. Whereas the control film was produced by commercial single screw extrusion and evidenced less thermal oxidation impact attributed to the process.

In another exemplary embodiment, an optical film is prepared from the following ingredients: a base TPU resin (AG-8451 sold by Lubrizol) containing a light stabilizer produced by a reaction mass of bis (1,2,2,6,6-pentamethyl-4-piperidyl) sebacate and methyl 1,2,2,6,6-pentamethyl-4-piperidyl sebacate (equivalent to Tinuvin 292 sold by BASF, CAS No. 1065336-91-5) and 2-(2H-benzotriazol-2-yl)-4,6-bis(1,1-dimethylpropyl)-phenol as a first UV absorber (equivalent to Tinuvin 328 sold by BASF, CAS No. 25973-55-1), and a concentrate containing 9.5% of a second UV absorber, Phenol, 2-(5-chloro-2H-benzotriazol-2-yl)-6-(1,1-dimethylethyl)-4-methyl (equivalent to Tinuvin 326, sold by BASF CAS No. 3896-11-5, blended in a TPU resin of AG-8451 sold by Lubrizol.

Three different films (1-3) having a thickness of 15 mils were prepared with differing loadings of Tinuvin 326 concentrate. The properties of the three films are contained below in Table 2. It is shown that adding Tinuvin 326 concentrate to the resin composition still blocks a large portion of the UV light at 400 nm while maintaining desired transparency with a YI value that is below 2.0 even when making a thinner film.

TABLE 2

| | | | UV | |
|---|---|---|---|---|
| | Film | Conc Loading | Cutoff | % Transmission |
| | Thickness | (PPH) | (nm) | @ 400 nm |
| Film 1 | 15 mils | 7.0 | 393.4 | 13.3 |
| Film 2 | 15 mils | 8.5 | 397.4 | 3.5 |
| Film 3 | 15 mils | 10.0 | 396.8 | 4.7 |

| | Avg. % | Avg. % | | |
|---|---|---|---|---|
| % Light | Light | Light | | YI |
| Blocked @ | Blocked | Blocked | Avg. % T | ASTM |
| 400 nm | (380-400 nm) | (390-410 nm) | (400-900 nm) | E313 |
| 86.7 | 98.1 | 78.8 | 90.5 | 1.39 |
| 96.5 | 99.6 | 88.0 | 90.8 | 1.93 |
| 95.3 | 99.5 | 86.6 | 90.4 | 1.79 |

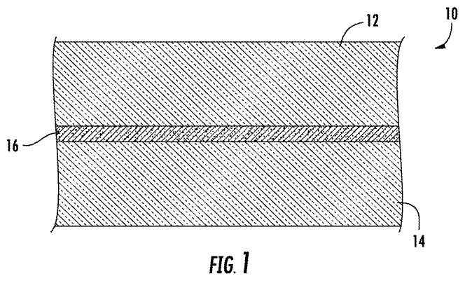

Referring now to FIG. 1, a composite 10 comprises first and second layers of glass 12, 14 and a film 16 between the first layer and the second layer of glass. Film 16 may include any of the compositions described above. In certain embodiments, a window is provided that includes the composite. Film 16 may be laminated between at least two sheets of glass substrates facing each other in order to reflect light rays having particular wavelengths in the infrared region.

Glass layers 12, 14 may comprise any clear or ultraclear glass of a type that is suitable for use in for image sensors, electronic display screens for computers and mobile devices, food packaging, optical disk devices, appliances and the like. Examples include PPG Clear glass, Solarphire® glass or PPG Starphire® glass. Clear glass is preferred so that when the window is illuminated with sunlight, less energy from IR light will be absorbed in glass layer 12 and more energy will be reflected back out of the outside layer of glass and away from the window. Ultraclear glass is more preferred because it absorbs less energy from IR light than clear glass and because it's higher transmittance allows more light to be reflected.

There are of course, other substantially clear materials that can be used as layers 12, 14 to provide rigidity and strength to an optical sheet. These alternative materials include polymeric materials such as, for example, acrylic, polyethylene teraphthalate (PET) or polycarbonate. A glazing component can be substantially planar or have some curvature. It can be provided in various shapes, such as a dome, conical, or other configuration, and cross-sections, with a variety of surface topographies. The devices and methods described herein are not intended to necessarily be limited to the use of any particular glazing component material(s) or structure.

Persons skilled in the art will understand that the products and methods specifically described herein are non-limiting exemplary embodiments. The features illustrated or described in connection with one exemplary embodiment may be combined with the features of other embodiments. Various alternatives and modifications can be devised by those skilled in the art without departing from the description. Accordingly, the present description is intended to embrace all such alternatives, modifications and variances. As well, one skilled in the art will appreciate further features and advantages based on the above-described embodiments. Accordingly, the devices and methods herein are not to be limited by what has been particularly shown and described, except as indicated by the appended claims.

Hereby, all issued patents, published patent applications, and non-patent publications that are mentioned in this specification are herein incorporated by reference in their entirety for all purposes, to the same extent as if each individual issued patent, published patent application, or non-patent publication were specifically and individually indicated to be incorporated by reference.

While several embodiments have been shown in the drawings, it is not intended that the description be limited thereto, as it is intended that the description be as broad in scope as the art will allow and that the specification be read likewise. Therefore, the above description should not be construed as limiting, but merely as exemplifications of presently disclosed embodiments. Thus the scope of the embodiments should be determined by the appended claims and their legal equivalents, rather than by the examples given.

Persons skilled in the art will understand that the devices and methods specifically described herein and illustrated in the accompanying drawings are non-limiting exemplary embodiments. The features illustrated or described in connection with one exemplary embodiment may be combined with the features of other embodiments. Various alternatives and modifications can be devised by those skilled in the art without departing from the description. Accordingly, the present description is intended to embrace all such alternatives, modifications and variances. As well, one skilled in the art will appreciate further features and advantages based on the above-described embodiments. Accordingly, devices and methods herein are not to be limited by what has been particularly shown and described, except as indicated by the appended claims.

What is claimed is:

1.-38. (canceled)

39. An optical film comprising:
a resin composition comprising:
one or more thermoplastic polyurethane (TPU) resins;
a first UV absorber selected from the group consisting of the benzotriazole family or the triazin family;
a light stabilizer; and
a second UV absorber selected from a group consisting of benzotriazoles, benzophenones, triazin or benzylidene malonate.

40. The optical film according to claim 39, wherein at least one of the TPU resins comprises an aliphatic TPU resin in an amount from about 95% to about 99.99% by weight.

41. The optical film according to claim 39, wherein at least one of the TPU resins comprises an aliphatic polyether based TPU.

42. The optical film according to claim 39, wherein the first UV absorber is present in the TPU resin in an amount from about 0.1 to about 1% by weight.

43. The optical film according to claim 39, wherein the light stabilizer is an amine light stabilizer (HALS).

44. The optical film according to claim 39, wherein the light stabilizer is produced by a reaction mass of bis (1,2,2,6,6-pentamethyl-4-piperidyl) sebacate and methyl 1,2,2,6,6-pentamethyl-4-piperidyl sebacate.

45. The optical film according to claim 39, wherein a thickness of the film is from about 5 mils to about 50 mils.

46. The optical film according to claim 39, wherein a combination of the first and second UV absorber is present in an amount from about 0.1 to about 3% by weight.

47. The optical film according to claim 39, wherein the second UV absorber is present in an amount from about 0.01 to about 2% by weight.

48. The optical film according to claim 39, wherein the film is capable of blocking at least about 95% of light having a wavelength ranging from about 380 nm to about 410 nm.

49. The optical film according to claim 39, wherein a YI value of the film is no greater than about 4.5.

50. The optical film according to claim 39, wherein the film is capable of blocking no less than about 99.5% of light having a wavelength ranging from about 380 nm to about-400 nm, and wherein a YI value of the film is less than about 2.0.

51. The optical film according to claim 39, wherein the film is capable of blocking no less than about 99.5% of light having a wavelength of about 400 nm.

52. The optical film according to claim 39, wherein the second UV absorber is combined with the one or more TPU resins as a concentrate in a base resin, and the ratio of the one or more TPU resins to the base resin ranges from about 20:1 to about 3:1.

53. The optical film according to claim 39, wherein the second UV absorber is combined with the one or more TPU resins as a concentrate in a base resin, and wherein a loading percentage of concentrate in the base resin ranges from about 0.5% to about 10%.

54. The optical film according to claim 39, wherein the second UV absorber is combined with the one or more TPU resins as a concentrate in a base resin, and a loading percentage of the second UV absorber as a concentrate is about 0.5% by weight in a base resin, and a thickness of the film is no greater than 30 mils.

55. The optical film according to claim 39, wherein a concentration loading of the second UV absorber is about 8.5 PPH and a thickness of the film is no greater than 15 mils.

56. The optical film according to claim 39, wherein the film exhibits adhesion to a glass, polycarbonate, acrylic, or cellulose acetate surface in the absence of an adhesive.

57. The optical film according to claim 39, wherein the resin composition comprises a combination of:
a first component comprising the one or more first thermoplastic polyurethane (TPU) resins, the first UV absorber, and the light stabilizer; and
a second component comprising the second UV absorber and a base resin, wherein the base resin is the same or different than one or more of the first thermoplastic polyurethane (TPU) resins.

58. The optical film according to claim 57, wherein one or both of the first thermoplastic polyurethane (TPU) resin and the base resin is an aliphatic polyether based TPU.

59. A composite comprising:
a first layer of glass;
a second layer of glass; and
an optical film positioned between the first layer and the second layer of glass, the optical film comprising a resin composition comprised of one or more thermoplastic (TPU) resins, a first UV absorber selected from the group consisting of the benzotriazole family or the triazin family, a light stabilizer, and a second UV absorber selected from a group consisting of benzotriazoles, benzophenones, triazin or benzylidene malonate.

60. The composite of claim 59, wherein at least one of the TPU resins comprises an aliphatic TPU resin in an amount from about 95% to about 99.99% by weight.

61. The composite of claim 59, wherein the first UV absorber is present in the TPU resin in an amount from about 0.1 to about 1% by weight.

62. The composite of claim 59, wherein the second UV absorber resides in a base resin, and wherein the base resin comprises a second TPU resin, which is the same or different as the one or more thermoplastic (TPU) resins.

63. The composite of claim 59, wherein a ratio of the TPU resin to the base resin is from about 20:1 to about 3:1.

64. The composite of claim 59, wherein the second UV absorber is added to the base resin as a concentrate, wherein a loading percentage of concentrate in the base resin ranges from about 0.5% to about 10%.
